(19) United States
(12) Patent Application Publication
(10) Pub. No.: US 2026/0316187 A1
(43) Pub. Date: Oct. 15, 2026

(54) DEVICE AND METHOD FOR MACHINING A WORKPIECE

(71) Applicant: TRUMPF Laser SE, Schramberg (DE)

(72) Inventors: Jonas Kleiner, Leonberg (DE); Daniel Flamm, Ludwigsburg (DE); Jonas Mayer, Harthausen (DE)

(21) Appl. No.: 19/683,783

(22) Filed: May 21, 2026

Related U.S. Application Data
(63) Continuation of application No. PCT/EP2024/082780, filed on Nov. 19, 2024.

(30) Foreign Application Priority Data
Nov. 28, 2023 (DE) 10 2023 133 294.5

(51) Int. Cl. B23K 26/36; B23K 26/064; B23K 26/082; B23K 26/352

(52) U.S. Cl. CPC B23K 26/36; B23K 26/0648; B23K 26/082; B23K 26/352

(57) ABSTRACT

A device for machining a workpiece by impressing an anti-glare functionalization with laser pulses, including a laser configured to provide a laser beam with laser pulses and a first and second diffusing lens configured to scatter the laser beam and impress a locally randomized intensity distribution onto the laser beam in a focal plane. The first diffusing lens scatters the laser beam and the second diffusing lens scatters the scattered laser beam. An optical focusing system is configured to focus the laser beam onto a focus zone in the focal plane on the workpiece. The laser beam is applied to the workpiece. An advancing device moves the laser beam and the workpiece relative to one another and includes a scanner having a first and second scanner element. The second scanner element includes the second diffusing lens. Movement of the scanner elements modifies the locally randomized intensity distribution.

### CROSS REFERENCE TO RELATED APPLICATIONS

This application is a continuation of International Application No. PCT/EP2024/082780 (WO 2025/114071A1 ), filed on Nov. 19, 2024, and claims benefit to German Patent Application No. DE 10 2023 133 294.5, filed on Nov. 28, 2023. The aforementioned applications are hereby incorporated by reference herein.

### FIELD

The present invention relates to a device and to a method for machining a workpiece.

### BACKGROUND

It is known that, during laser material machining, material of a workpiece can be removed by vaporizing or compressing the material within the focus zone of the laser beam through a strong light-matter interaction. The resulting structures are called dimples. In this regard, dimples are suitable for functionalizing the surfaces of components, wherein optical properties and tribological properties in particular can be influenced.

However, when machining a material with a pulsed laser, regular structures are often created, in particular regularly arranged dimples, for example, due a beat between the repetition frequency of the laser system and other process parameters such as the advancing rate and the number of repetitions of material passes. Such regular structures can, for example, lead to interference effects when viewed that disturb the visual impression of the machined material.

U.S. Patent Application No. 2017/0368638 A1 relates to the machining of materials using high-power lasers with shapable beams and/or variable beam polarizations.

### SUMMARY

In an embodiment, the present disclosure provides a device for machining a workpiece by impressing an anti-glare functionalization with laser pulses, comprising a short-pulse laser or an ultra-short-pulse laser configured to provide a laser beam with laser pulses and a first diffusing lens and a second diffusing lens each configured to scatter the laser beam and to impress a locally randomized intensity distribution onto the laser beam in a focal plane. The first diffusing lens scatters the laser beam and the second diffusing lens scatters the scattered laser beam. The device further comprises at least one optical focusing system configured to focus the laser beam onto a focus zone in the focal plane on the workpiece. The laser beam is applied to the workpiece and the workpiece is machined as a result of the laser beam being applied to the workpiece. The device further comprises an advancing device configured to move the laser beam and the workpiece relative to one another. The advancing device comprises a scanner having a first scanner element and a second scanner element. A movement of the first and second scanner elements produces an advancement. The second scanner element comprises the second diffusing lens. The movement of the first and second scanner elements modifies the locally randomized intensity distribution.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1A, FIG. 1B, FIG. 1C, FIG. 1D, FIG. 1E and FIG. 1F show schematic representations of a device according to an embodiment of the present disclosure;

FIG. 2A, FIG. 2B, FIG. 2C and FIG. 2D show schematic representations of a device according to an embodiment of the present disclosure;

FIG. 3A, FIG. 3B and FIG. 3C show schematic representations of an operating principle of a beam shaping device;

FIG. 4 shows a schematic representation of a device according to an embodiment of the present disclosure;

FIG. 5 shows a schematic representation of a scanner device; and

FIG. 6A and FIG. 6B show schematic representations of a method according to an embodiment of the present disclosure.

### DETAILED DESCRIPTION

In an embodiment, the present disclosure provides an improved device for machining a material, as well as a corresponding method.

A device for machining a workpiece, in particular for impressing an anti-glare functionalization, by means of laser pulses of a laser, is provided, comprising a laser, in particular a short-pulse laser or an ultra-short-pulse laser, which is configured to provide a laser beam with laser pulses; a first diffusing lens and a second diffusing lens, which are each configured to scatter the laser beam and to impress a locally randomized intensity distribution onto the laser beam in the focal plane, wherein the first diffusing lens and the second diffusing lens successively scatter the laser beam; at least one optical focusing system, which is configured to focus the laser beam onto a focus zone in the focal plane on the workpiece, wherein the laser beam is applied to the workpiece and as a result the workpiece is machined; an advancing device, which is configured to move, with an advancement, the laser beam and the workpiece relative to one another, wherein the advancing device comprises a scanner device having a first scanner element and a second scanner element, wherein a movement of the scanner elements produces an advancement. According to an embodiment of the present disclosure, the second scanner element is designed as a second diffusing lens, wherein the movement of the scanner elements modifies the locally randomized intensity distribution.

Here, the material of the workpiece can be, for example, a polymer or a plastic. The material to be machined can also be a semiconductor, for example an elemental semiconductor such as silicon or germanium, or a III-V semiconductor such as gallium arsenide, or an organic semiconductor, or any other type of semiconductor. By way of example, the material can be a silicon wafer. However, the material can comprise any metal, such as aluminum, magnesium, titanium, iron, or a steel alloy. In particular, the material can be a layer system, wherein each layer can be chosen from the group of any metals, polymers, plastics, or semiconductors. In particular, the material can also be glass, for example, sapphire or quartz glass.

The laser provides the laser pulses of the laser beam, wherein the individual laser pulses form the laser beam in the beam propagation direction. The pulse duration of the laser pulses can range from 100 fs to 100 ps. The wavelength of the laser pulses can be between 300 nm and 3000 nm, preferably between 900 nm and 2200 nm.

Instead of individual laser pulses, the laser can also provide laser bursts, wherein each burst comprises the emission of a plurality of laser pulses. In this case, the laser pulses can be emitted very shortly after one another, spaced apart by a few picoseconds to nanoseconds, for a specific time interval. In particular, the laser bursts can be GHz bursts, in which the succession of successive laser pulses in the respective burst occurs in the GHz range. For example, a burst can contain between 2 and 20 laser pulses, preferably between 2 and 10 laser pulses, with the time interval between the laser pulses being between 10 ns and 50 ns. However, a burst can also comprise between 30 and 300 laser pulses, with the time interval between the laser pulses being between 100 ps and 1000 ps.

The repetition rate of the laser pulses and/or laser bursts can be greater than 1 kHz, preferably greater than 10 kHz. For example, the repetition rate can be 100 kHz or more. For example, more than 1000 pulses per second or more than 10,000 pulses per second are emitted by the laser

The pulse energy of the laser pulses can exceed 1 μJ; for example, it can be 2 μJ.

The diameter of the laser beam provided by the laser can be larger than 0.1 mm, for example 1 mm or 5 mm.

The laser pulses are introduced into the material after passing through the rest of the device, wherein the energy of the laser beam is at least partially absorbed in the material, for example, by nonlinear interactions, in particular by multiphoton processes.

The incoming laser beam first passes through the first diffusing lens and then through the second diffusing lens. Such a diffusing lens is designed to scatter the laser beam. In particular, this can mean that the laser beam is converted into a plurality of partial laser beams, wherein each partial laser beam has its own propagation direction and/or its own intensity and/or its own phase front. In particular, the beam propagation direction of the partial laser beams can differ from that of the incoming laser beam.

The scattering of the laser beam depends both on the point of incidence on the first diffusing lens and on the point of incidence on the second diffusing lens.

The plurality of partial laser beams are superimposed on a focus zone on the focal plane by an optical focusing system, for example a 2 f optical system. Here, the focus of the scattered laser beam can be located on the workpiece in the beam propagation direction. In this case, the focus is on the workpiece where the focal plane coincides exactly with the surface of the workpiece, or lies above or below the surface in the beam propagation direction, wherein the surface is still being machined. In particular, the focal position can be within ten times the Rayleigh length from the surface, wherein the Rayleigh length is the distance along the optical axis that a laser beam needs until its cross-sectional area doubles, starting from the beam waist or the focus.

In particular, the term “focus” can generally be understood as a targeted increase in intensity, wherein the laser energy converges in a “focus zone”. In particular, the term “focus” is therefore used below irrespective of the actual beam shape used and the methods used to bring about an increase in intensity. The location of the focus zone along the beam propagation direction can also be influenced by focusing. For example, the focus zone can be virtually punctiform and have a Gauss-shaped intensity cross-section, as is provided by a Gaussian laser beam. However, the focus zone can also be designed as a line or a rectangle, or take the form of an Airy distribution. Furthermore, other more complex beam shapes can also be provided, with a focal position that extends in three dimensions, such as a multi-spot profile consisting of or comprising Gaussian laser beams and/or non-Gaussian intensity distributions.

As a result of the energy absorbed from the laser beam in the focus zone, the material heats up in accordance with the intensity distribution of the laser in the focus zone and/or transitions into a temporary plasma state due to the electromagnetic interaction between the laser and the material. In particular, in addition to linear absorption processes, non-linear absorption processes can also be used, which become accessible through the use of high laser energies or laser intensities. Accordingly, the material is modified particularly in the focus zone of the laser, as this is where the intensity of the laser beam is greatest. What this can achieve, in particular, is that some of the material can be released from the composite of the material of the workpiece, for example, by melting or vaporizing it. Hence, machining processes known per se are provided in relation to the interaction between the laser beam and the material of the workpiece to be machined, these methods being known, for example, as laser drilling, percussion drilling, laser ablation, blasting, or compaction.

The interaction of the laser pulses with the material of the workpiece to be machined causes corresponding material modifications to occur on the surface of the workpiece. In particular, a material modification can be created using a laser pulse or a laser burst.

Such a material modification is created by the vaporization of the material of the workpiece on the surface due to the irradiated laser intensity. The material of the workpiece is vaporized particularly where the intensity of the laser beam exceeds a critical, material-specific machining threshold. Accordingly, the shape and form of the laser beam, in particular the intensity distribution of the laser beam on the focal plane, is crucial for the shape and form of the material modification.

Without a diffusing lens, for example, the laser beam has only a Gaussian beam profile. A certain spatial region is formed around the focal point in which the laser energy is above the critical machining threshold. In other words, there is an isointensity area within the intensity distribution of the laser beam in the focus where the material can be vaporized. The shape and form of the material modification is determined from this isointensity area. In particular, material modifications can therefore have a round or elliptical cross-section in the plane of the material surface, wherein the material modifications have an increasing depth from the edge to the center. In particular, the cross-section of the material modifications in the plane perpendicular to the surface can also be round or rounded. However, the material modification can have an elliptical or circular cross-section in the plane of the material surface, but have a steep edge slope, so that a substantially rectangular cross-section of the material modification results in the plane perpendicular to the material surface. For example, such a material modification can also have a uniform depth.

However, when the first and second diffusing lenses are placed in the beam path of the device, the laser beam is randomly scattered, resulting in a locally randomized intensity distribution in the focal plane. Accordingly, the laser beam incident on the first diffusing lens is scattered into a plurality of partial laser beams, the intensities and angles of propagation of which are randomly distributed, or statistically distributed, for example, normally distributed or correspond to a Gaussian distribution. The intensities and propagation angles can also be distributed statistically in a band-limited manner, so that the largest and smallest propagation angles of the partial laser beams are determined by the shape and form of the diffusing lens.

Scattering occurs again when the partial laser beams created by the first diffusing lens are incident on the second diffusing lens and are scattered there. The scattering at the second diffusing lens depends on where the laser beam is incident on the second diffusing lens after the first scattering.

This impresses a double-random or statistical component onto the intensity profile in the focal plane, which exhibits locally randomly distributed peaks and troughs in intensity, each of which provides for a particularly strong or particularly weak machining of the material. In particular, such scattering can impress a kind of speckle pattern on the laser beam on the focal plane, as defined for example inGoodman “Speckle phenomena in optics: theory and applications,” Roberts and Company Publishers, 2007. This locally randomized intensity distribution allows the material to be machined in an inhomogeneous manner, thereby avoiding regular and/or smooth machining patterns in the individual material modifications.

By introducing such inhomogeneous material modifications with the aid of a locally randomized intensity distribution on the surface of the material, the optical properties of the material can be determined, for example, by light passing through a transparent material being scattered at such a material modification, thus making the material appear diffuse and/or matte. In particular, such material modifications on the surface of the material of the workpiece can reduce reflection on the material.

For example, the feel or roughness can be adjusted by the type and shape of the material modifications, as well as the distribution of the material modifications on the surface of the component. However, the scattering of light and thus the optical properties of the material can be adjusted.

In particular, the material modifications can be used to create an anti-glare functionalization. An anti-glare functionalization can then consist of or comprise an incident light beam not only being reflected from the surface at the angle of reflection according to Snell's law of refraction. In particular, it can also be the case that the incident light beam is reflected or scattered from the surface at other angles. In particular, the incident light beam is guided in different spatial directions so that no sharp reflection occurs, in the sense that the entire energy of the incident light beam can be detected at a certain angle of reflection. Rather, the energy of the incident light is distributed over a spatial region so that the energy of the incident light beam can be detected in a range of angles of reflection.

The advancing device can be configured to move, with an advancement, the laser beam and the workpiece relative to one another, wherein the advancing device comprises a scanner device having a first scanner element and a second scanner element, wherein a movement of the scanner elements produces an advancement. “Displaceable relative to one another” means that the laser beam can be displaced in translation relative to a stationary material and also the material can be displaced relative to the laser beam, or both the material and the laser beam can be moved.

In particular, this allows the focus zone of the laser beam to be placed at different locations on the material in order to introduce laser pulses. In this case, the laser pulses are located specifically along the so-called advancing trajectory. The advancing trajectory can, for example, be straight or curved. In particular, the local advancing direction is always the y-direction, while the z-axis is parallel to the surface normal and the x-axis is aligned perpendicular to the y-axis parallel to the material surface.

For example, the laser beam can be moved along with an advancement while the laser pulses are emitted into or onto the material, so that the different focus zones can be arranged next to one another or even overlap in order to enable uniform and planar machining of the workpiece.

The advancing device thus makes it possible, in particular, to change the position of the laser relative to the workpiece so that successively emitted laser pulses machine the workpiece at different locations. Accordingly, the laser beam can cover the entire surface of the workpiece and thus perform a planar material machining.

The scanner elements of the scanner device can be configured to displace the laser beam along different axes on the workpiece. For example, the first scanner element can create a displacement in the x-direction, while the second scanner element creates a displacement in the y-direction. By superimposing both displacements, the laser beam can be displaced in the x-y plane using the scanner elements.

According to an embodiment of the present disclosure, the second scanner element is designed as a second diffusing lens. Accordingly, creating an advancement can also modify the locally randomized intensity distribution, since the second diffusing lens already provides scattering on the basis of the point of incidence of the light scattered by the first diffusing lens.

The phrase “the scattering element comprises” can mean in this context that the second scanner element itself has both a beam-deflecting effect and a scattering effect, i.e., the second scanner element and the second scattering element are designed in one piece. For example, the second scanner element can have a coating that has a corresponding scattering and deflecting effect. However, the second scattering element and the second scanning element can be designed as a single functional unit, such as when the second diffusing lens is positioned directly behind the scanner element. In particular, the second diffusing lens and the second scanner element can be mechanically connected so that movement of the second scanner element causes the second diffusing lens to move. However, the second scanner element can also be moved independently of the second diffusing lens.

By displacing the second scanner element, the point of incidence of the laser beam scattered by the first diffusing lens on the second diffusing lens can be changed. Due to the changed scattering properties at the different points of incidence, a first laser pulse can have a first locally randomized intensity distribution, while a second laser pulse can have a second locally randomized intensity distribution, wherein the intensity distributions are different. This makes it possible to avoid periodic, recurring patterns in the material modifications, thus enabling particularly high-quality material machining.

A particular advantage is that, due to the double scattering at the first and second diffusing lenses, even a small change in the second scanner element can result in a significant difference in the local randomization of the intensity distribution.

In particular, however, using the scanner device as a scattering device makes it possible to dispense with a separate second scattering device.

Because the scanning motion can be used to randomize the intensity distribution, the device is also suitable for impressing anti-glare functionalizations using particularly high laser energies. For example, according to the prior art, rapid repositioning of the laser beam is required to achieve a random intensity distribution. However, high laser powers requires thick optical elements, which in turn result in high inertia. By randomizing the intensity distribution within the scanner device, which can have a low dynamic range, it is thus made possible to use optical elements that are suitable for high laser powers.

The first scanner element can be arranged before or after the first diffusing lens.

If the first scanner element is arranged after the first diffusing lens, the point of incidence of the laser on the first diffusing lens is not displaced by a scanner element, so that no variable randomization of the intensity distribution occurs at the first diffusing lens. However, the scattered laser beam is displaced by the first scanner element, causing the point of incidence of the scattered laser beam on the second diffusing lens to change. Thus, the advancement of the first and second scanner elements results in a variable randomization of the intensity distribution.

If the first scanner element is arranged in front of the first diffusing lens, the different points of incidence on the first diffusing lens alone already result in variable, randomized scattering.

The first scanner element can also comprise the first diffusing lens as described above. As a result, the first and second scanner elements, in particular, can be designed as identical. In particular, this offers the same technical advantages as described above.

At least one diffusing lens can be configured to scatter the laser beam in transmission or reflection. In particular, however, both diffusing lenses can also be configured to transmit or reflect the laser beam.

For example, a diffusing lens can transmit the incident laser beam, allowing the laser beam to propagate through the diffusing lens while being scattered in the process. For example, the laser beam can be scattered on a diffusing lens so that it does not pass through the diffusing lens but is reflected by it. For example, the diffusing lens can be a mirror that is not planar but has an irregular pattern.

At least one diffusing lens can have a phase pattern, in particular a binary phase pattern, which is configured to impress a location-dependent phase difference on the laser beam, in particular, the phase pattern can be defined in one or two dimensions.

In this context, the diffusing lenses have scatter regions that either locally affect or do not affect the phase of the incident laser beam. Here, the various scatter regions are randomly distributed across the diffusing lenses so that the scattering of the laser beam is dependent on the point of incidence on the respective diffusing lens. For example, after being scattered by the first diffusing lens, a first partial laser beam can exhibit a phase shift relative to a second partial laser beam in a first scatter region. Such a phase shift makes it possible to deflect the partial laser beams from their original propagation direction.

The number of different phase shifts that can be created using the diffusing lenses is determined by what is known as the phase quantization of the diffusing lens. At a phase quantization of 2, the diffusing lens exhibits a binary phase pattern. With a binary phase pattern, only two phase shifts can be created between the partial laser beams, for example 0° and 180°. With a phase quantization of the diffusing lens of four, four different phase shifts can be created, for example 0°, 45°, 90°, 180°. However, the diffusing lens can allow, for example, 8 or 16 different phase shifts between the partial laser beams.

For example, a first scatter region of the diffusing lens can have a first material thickness, and a second scatter region can have a second material thickness. If the diffusing lens is designed as reflective, the first thickness and the second thickness can be selected such that the path difference of the reflected partial laser beams corresponds to half the wavelength. Accordingly, adjacent partial laser beams at the scatter regions have a phase difference of 180°.

However, the laser beam can be transmitted through a diffusing lens with scatter regions of different thicknesses, wherein the different thicknesses of the scatter regions provide different optical path lengths. If the optical path lengths differ by half a wavelength, the partial laser beams have a phase difference of 180°.

If the diffusing lens has a binary pattern, this can mean that the diffusing lens only provides two different optical path lengths. The pattern can be distributed over the geometric extent of the diffusing lens so that the diffusing lens has, for example, statistically distributed regions of a first thickness and a second thickness.

If a diffusing lens exhibits a binary pattern in two dimensions, this can mean that the diffusing lens has randomly distributed scatter regions in both height and width. However, if a diffusing lens exhibits a binary pattern in only one dimension, this can mean that the diffusing lens has randomly distributed scatter regions only in height or width. For example, the binary pattern then corresponds to a striped pattern.

In particular, the spatial frequency of the locally randomized intensity distribution can be adjusted by varying the size of the scatter regions of the respective diffusing lens. The spatial frequency can be understood as the inverse of the period length of the scatter regions. If, for example, the diffusing lens has small rectangular scatter regions, this leads to a large spatial frequency of the locally randomized intensity distribution and thus to a particularly inhomogeneous intensity distribution.

For example, the edge length of the pixels can be larger than 1 μm, for example 20 μm or 100 μm.

The diffusing lens can be a spatial light modulator or a diffractive optical element.

A spatial light modulator can be, for example, a nano grating or a hybrid element, which can impress a defined phase distribution on the laser beam by way of its inherent structure or configuration. For example, a light modulator can also be a spatial light modulator, the cells or pixels of which modulate the laser beam through adjustable birefringent properties. Accordingly, a spatial light modulator can, for example, be implemented as an LCD (liquid crystal display).

A diffractive optical element is designed, similarly to the light modulator, to influence the incident laser beam in one or more properties in two spatial dimensions. In contrast to an LCD-based spatial light modulator, a diffractive optical element is a fixed component that can be used to produce exactly one beam shape from the incident laser beam. Typically, a diffractive optical element is a specifically formed diffraction grating, wherein the laser beam is brought into the desired beam shape by the diffraction.

The diffractive optical element can be implemented as a geometric-phase hologram in which the diffractive effect exhibits polarization dependence; see Kim et al., “Fabrication of ideal geometric-phase holograms with arbitrary wavefronts,” Optica 2, 958-964 (2015). Furthermore, the geometric-phase hologram can be designed as a switchable element, and in particular as a binarily switchable element.

The advancing device can comprise an axis device.

For example, the material can be moved mechanically using the axis device. In particular, the axis device can be an XYZ table with a stepping motor control. However, the axis device can be designed with piezo adjustments in order to achieve the fastest possible adjustment.

For example, the axis device can be used to perform coarse positioning of the workpiece, while the scanner device scans the workpiece relative to it along the advancing trajectory.

The scanner device can comprise a galvanometer scanner and/or a polygon scanner.

In a galvanometer scanner, the laser beam is repositioned with high precision and repeatability. In particular, a one-dimensional galvanometer scanner deflects the laser beam in only one direction, while a two-dimensional galvanometer scanner deflects the laser beam in two different directions, which are preferably orthogonal in relation to one another.

In a polygon scanner, the laser beam is directed onto a rotating polygonal mirror, which periodically deflects the laser beam onto the workpiece. The polygonal mirror is composed of various facets, each of which can comprise its own diffusing lens.

These components enable material machining using particularly high laser energies, as they move relatively slowly and are therefore suitable also for heavy-duty, high-performance components.

The optical focusing system can also comprise a diffusing lens. In particular, the side facing the workpiece can comprise a diffusing lens or be designed as a diffusing lens. This allows the intensity distribution on the workpiece to be further randomized.

A beam shaping device can be configured to impress a specific beam shape on the laser beam, in particular a flat-top beam shape, wherein the beam shaping device is preferably arranged in front of the scanner device.

A beam shaping optic can, for example, be a commercially available Pi-Shaper, which impresses a flat-top beam shape on the laser beam. Compared to a Gaussian laser beam, a flat-top laser beam has a homogeneous intensity across the beam cross-section, which drops rapidly after reaching the beam diameter. In a sense, the flat-top laser beam has a largely rectangular intensity profile, while the intensity profile of a Gaussian laser beam has a Gaussian intensity profile.

A flat-top laser beam provides a particularly simple beam shape. For example, flat-top laser beams make it particularly easy to create several adjacent material modifications that are adjacent to one another or partially overlap, since the intensity variations at the edge of a Gaussian laser beam do not need to be compensated.

An aperture can also be arranged in the beam path. The aperture makes it possible to adjust the beam profile. This makes it possible to generate a beam profile with the desired length and radial intensity distribution.

This ensures that when material modifications are introduced in adjacent areas, a homogeneous modified area is created in which the transitions are not visible.

Accordingly, a method for machining a workpiece, in particular for impressing an anti-glare functionalization, by means of laser pulses of a laser, in particular a short-pulse laser or an ultra-short-pulse laser, is provided, wherein the laser beam is scattered by the laser pulses via a first diffusing lens and a second diffusing lens, and a locally randomized intensity distribution is impressed on the laser beam in the focal plane by the diffusing lenses, wherein the workpiece and the laser beam are displaced relative to one another along an advancing trajectory, wherein the advancement is created by the movement of a first scanner element and a second scanner element of a scanner device, wherein the scattered laser beam is focused by an optical focusing system onto a focus zone in a focal plane on the workpiece, wherein the laser beam is applied to the workpiece and as a result the workpiece is machined. According to an embodiment of the present disclosure, the second scanner element is designed as a second diffusing lens, and the relative movement of the scanner elements modifies the locally randomized intensity distribution.

The first scanner element can be arranged before or after the first diffusing lens and/or the first scanner element can comprise the first diffusing lens.

The focus zones of different, in particular successive, laser pulses can overlap.

By overlapping the material modifications, a continuous machined surface of the workpiece can be formed. This has the particular advantage that regular patterns, which result, for example, from a uniform offset of the laser beam with the advancing rate between two laser pulses, are avoided.

In particular, the focus zones can thus cover a planar section of the workpiece and machine it. The entire surface of the workpiece can also be machined.

A “planar section” refers herein to a contiguous region corresponding to the extent of at least two focus zones that has been machined, while a full-surface machining of the workpiece surface refers to machining at least the side facing the laser beam.

Embodiments of the present disclosure are explained in greater detail by way of the following description of the figures.

Preferred exemplary embodiments will be described below with the aid of the figures. In this case, elements that are the same, similar or have the same effect are provided with identical reference signs in the different figures, and a repeated description of these elements is omitted in some instances, in order to avoid redundancies.

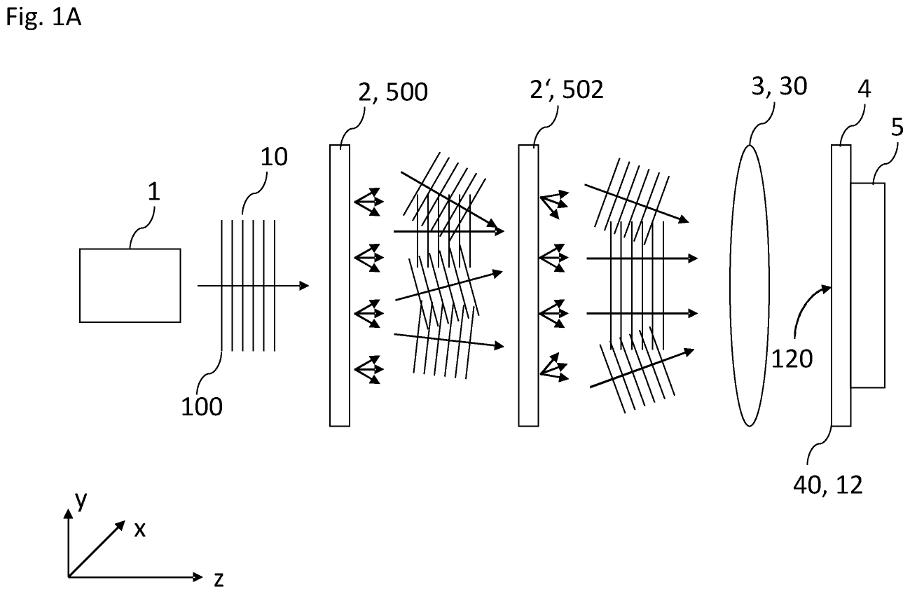

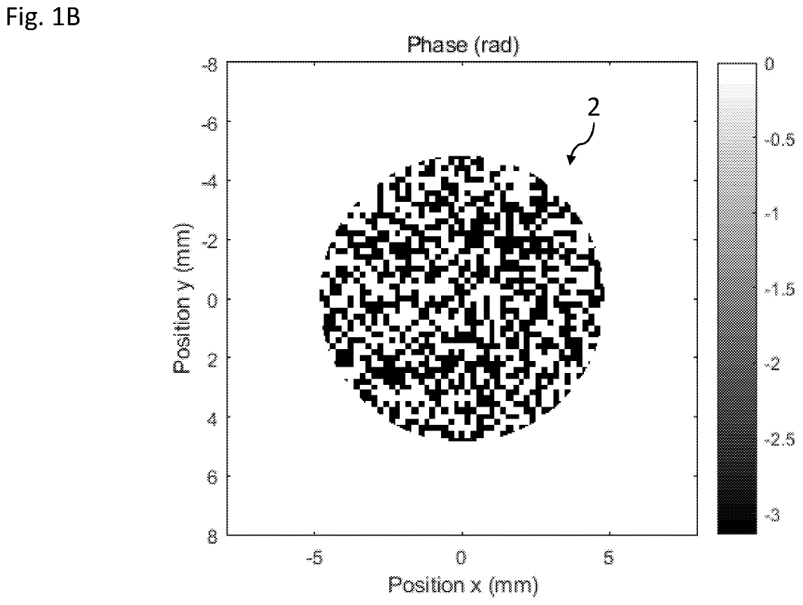

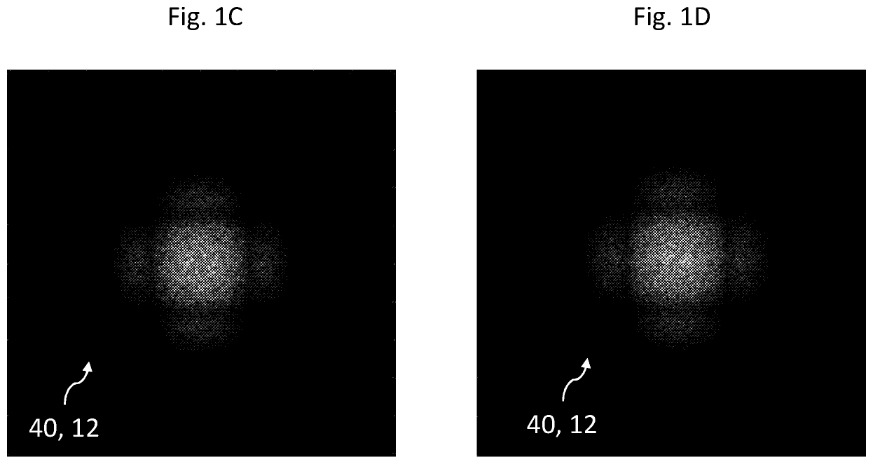

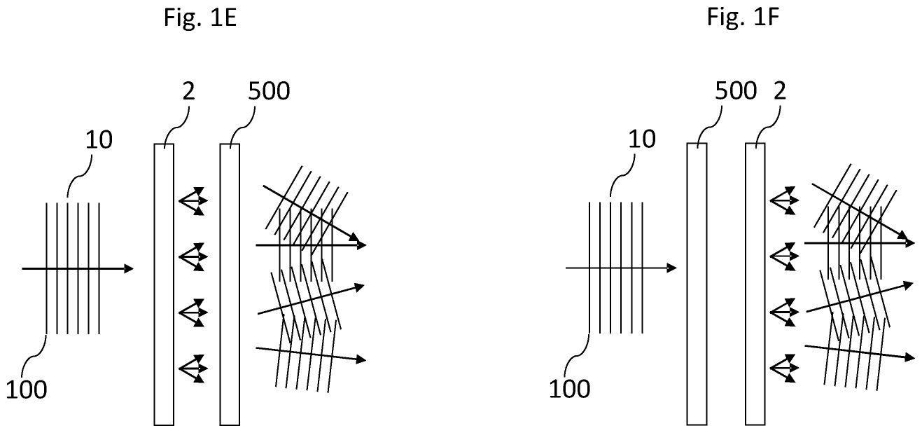

FIG. 1A schematically shows a device according to a first embodiment. The device comprises a laser 1, in particular a short-pulse laser or an ultra-short-pulse laser, which provides laser pulses 100 that form the laser beam 10. The laser beam 10 passes through a first diffusing lens 2 and then a second diffusing lens 2′, each of which scatters the laser beam 10, thereby forming a plurality of partial laser beams, the intensity and direction of propagation of which are randomized by the scattering. The partial laser beams scattered onto the second diffusing lens 2′ are randomized again there. An optical focusing system 3, consisting of or comprising a lens 30, focuses the scattered laser beam 10, or the plurality of partial laser beams, into a focus zone 120 in the focal plane 12, which, for example, coincides with the surface 40 of the workpiece 4. Accordingly, the focused and doubly scattered laser beam 10 exhibits a locally randomized intensity distribution in the focal plane 12, such that the surface 40 of the workpiece 4 is applied to inhomogeneously in the focus zone 120, thereby creating an inhomogeneous material modification.

FIG. 1B shows a schematic representation of a first diffusing lens 2. The diffusing lens has various scatter regions, which are arranged on a grid, for example in a shape reminiscent of rectangular pixels. The white scatter regions do not produce any phase shift here, while the black scatter regions produce a phase shift of 180° compared to the white scatter regions. Due to the randomized scatter regions, i.e., the random arrangement of scatter regions that produce a phase shift or no phase shift, the laser beam 10 that is transmitted through the diffusing lens 2 can be impressed with a randomized intensity distribution in the focal plane 12. The second diffusing lens 2′ is shaped accordingly, but has different randomized scatter regions.

The locally randomized intensity distributions created by the device shown in FIG. 1A are shown in FIGS. 1C and 1D. FIG. 1C shows the intensity distribution of the laser beam 10 in the focal plane 12 after a first pass through the diffusing lens 2 at a first point of incidence, and FIG. 1D shows a different intensity distribution during a second pass through the diffusing lens 2 at a second point of incidence. The intensity distributions differ from one another and thus produce different material modifications on the surface 40 of the workpiece 4.

The intensity distribution has a kind of coarse structure based on the shape of the pixel-shaped scatter regions. For example, diffraction at the rectangular pixels creates a sinc2-shaped envelope superimposed by a randomized intensity profile. The randomized intensity profile reflects the influence of the different scatter regions on the laser beam 10.

According to an embodiment of the present disclosure, the plurality of scattered partial laser beams is directed onto a second diffusing lens 2′ and scattered there once again. Since the scattering by the second diffusing lens 2′ also depends on the point of incidence of the partial laser beams, the already randomized intensity distribution is randomized once again.

The device shown in FIG. 1A also has an advancing device 5, which comprises a scanner device 50 with a first scanner element 500 and a second scanner element 502. The scanning device 50 can be designed to deflect the laser beam 10 and displace the laser beam along an advancing trajectory on the workpiece 4. To this end, the laser beam 10 is incident on the first scanner element 500, where the laser beam 10 is deflected, for example, in a first direction. The laser beam 10 is then incident on the second scanner element 502, wherein the laser beam 10 is then deflected along a second direction. The point of incidence of the laser beam on the second scanner element 502 depends in particular on the deflection and the point of incidence of the laser beam on the first scanner element 500.

According to an embodiment of the present disclosure, the first scanner element 500 comprises a first diffusing lens 2, and the second scanner element 502 comprises a second diffusing lens 2′. Accordingly, the movement of the first scanner element 500 and the second scanner element 502 not only causes the laser beam 10 to be displaced along an advancing trajectory across the workpiece 4, but also results in locally randomized intensity distributions being introduced into the workpiece 4 during the advancement. The advancement along the workpiece surface 40 is thus automatically linked to a locally randomized intensity distribution, without the need for additional means to randomize the intensity distribution.

FIGS. 1E and 1F show alternative embodiments of the first scanner element 500 and the first diffusing lens 2. Unlike in FIG. 1A, the first scanner element 500 does not comprise the diffusing lens 2; rather, the diffusing lens 2 is designed as spatially separated from the first scanner element 500.

In FIG. 1E, the diffusing lens 2 is arranged in the beam propagation direction in front of the scanner element 500. The scanner element 500 receives a laser beam that has already been scattered. The scanner element 500 therefore directs the scattered laser beam 10 to the second scanner element, where it is scattered again.

In FIG. 1F, the diffusing lens 2 is arranged in the beam propagation direction after the scanner element 500. The scanner element 500 therefore directs the unscattered laser beam 10 to different points of incidence on the diffusing lens 2 so that the laser beam is scattered differently at each point of incidence. Also in this case, the scattered laser beam is then directed onto the second scanner element and scattered again there. FIGS. 1E and 1F therefore also show a double randomization of the intensity distribution.

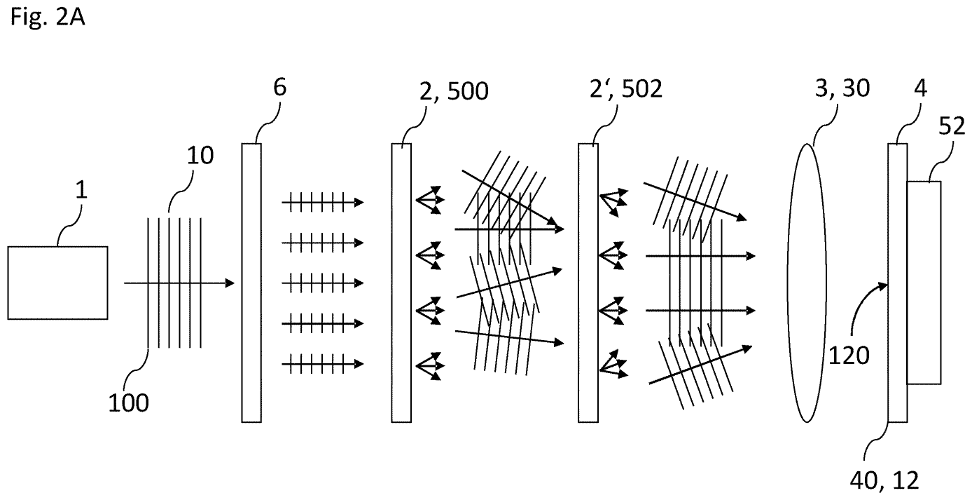

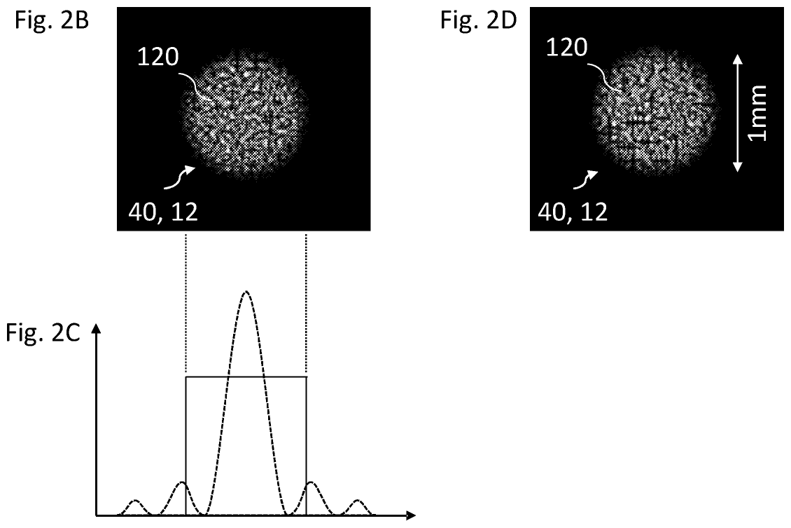

FIG. 2A shows a further embodiment of the device according to the present disclosure. Unlike in FIG. 1A, the laser beam 10 is additionally shaped by a beam shaping device 6. For example, a so-called flat-top beam is formed from the Gaussian laser beam of the laser so that the envelope of the intensity distribution in the focus zone 12 is made more uniform; see FIG. 2B.

The device also has two diffusing plates 2, 2′, through which the laser beam 10 passes one after the other. Here, the laser beam 10 scattered by the first diffusing plate 2 is scattered again by the second diffusing plate 2′. As a result, the different laser pulses 100 of the laser 1 experience different scattering, whereby laser pulses introduced consecutively into the material of the workpiece 4 also cause differently shaped material modifications.

FIG. 2B shows a first intensity profile of the scattered laser beam 10 on the focal plane 12. The intensity profile of the flat-top laser beam 10 provides a uniform illumination of a certain area, wherein the intensity distribution is sharply limited towards the edge of the area. The double scattering process creates a locally randomized intensity profile in the area, reminiscent of laser speckles. The locally randomized intensity distribution, for example, shows more than 100 local intensity maxima, which lead to a very inhomogeneous and irregular material modification.

FIG. 2C shows the envelope of the intensity distributions from FIG. 1C (dashed) and 2B (solid) in comparison. It is clearly visible that the sinc 2-shaped intensity profile in a Gaussian raw beam concentrates a large part of the intensity on a small spatial region, while planar machining of the workpiece 4 is significantly simplified with a flat-top laser beam.

FIG. 2D shows another intensity distribution that is created when the first diffusing lens 2 is displaced against the second diffusing lens 2′ during the scanning process. Since the first diffusing lens 2 and the second diffusing lens 2′ scatter the laser beam 10 differently at the displaced positions, a different spatially randomized intensity profile results in the focal plane 12. Repetitive randomized intensity distributions on the surface 40 of the workpiece 4 can thus be avoided. In FIGS. 2B, 2D, the diameter of the focus zone is about 1 mm so that the power of the laser is distributed over an area of about 0.8mm2 .

FIG. 3A schematically shows the operating principle of a flat-top beam shaper 6. The laser beam 10 running on the optical axis, which is incident on the beam shaping device 6, has a first diameter, which relates, for example, to the drop in intensity to 1/e2 of the intensity maximum of the laser beam 10. In the beam shaping device 6, the laser beam 10 can be reshaped by a combination of phase plates, spherical lenses and aspherical lenses. For example, the partial laser beams that form the intensity maximum of the incident laser beam 10 can be distributed away from the optical axis, so that although there is a lower maximum intensity on the optical axis, there is a uniform intensity profile over a larger area. The partial laser beams can then be parallelized again, forming the flat-top laser beam 10′. The diameter of the flat-top laser beam can be larger than that of the Gaussian laser beam.

Depending on the beam diameter of the incident laser beam 10, different beam shapes can be created with the same beam shaping device 6, see for example Laskin et al. “Variable beam shaping with using the same field mapping refractive beam shaper.” Laser Resonators, Microresonators, and Beam Control XIV. Vol. 8236. SPIE, 2012. In FIG. 3B, the incident laser beam 10 has a larger diameter than in FIG. 3A. This results in edge peaks forming on the intensity profile of the flat-top laser beam after the beam shaping device 6. In FIG. 3C, the incident laser beam 10 has a smaller diameter than in FIG. 3A. As a result, the flat-top laser beam 10′ has a lower edge steepness.

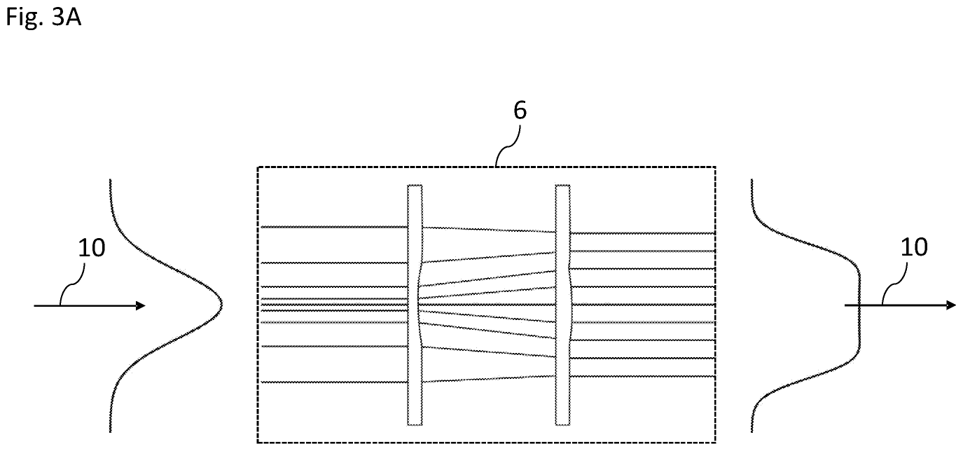

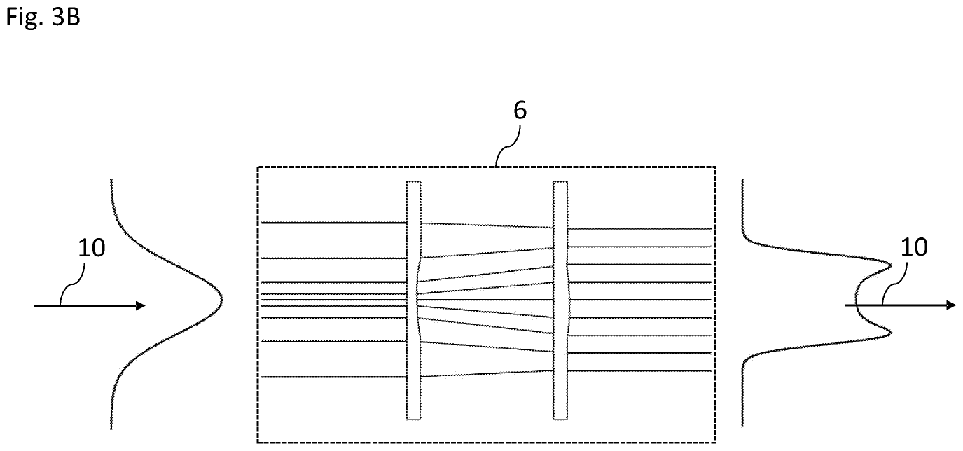

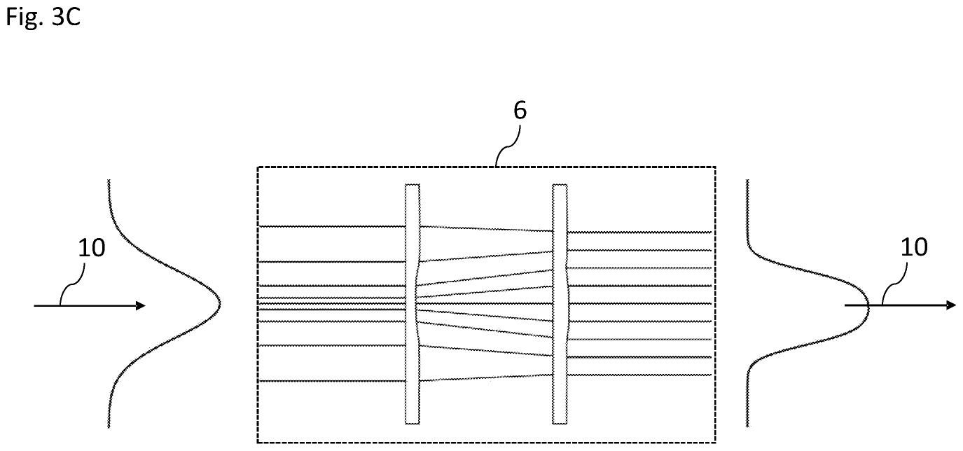

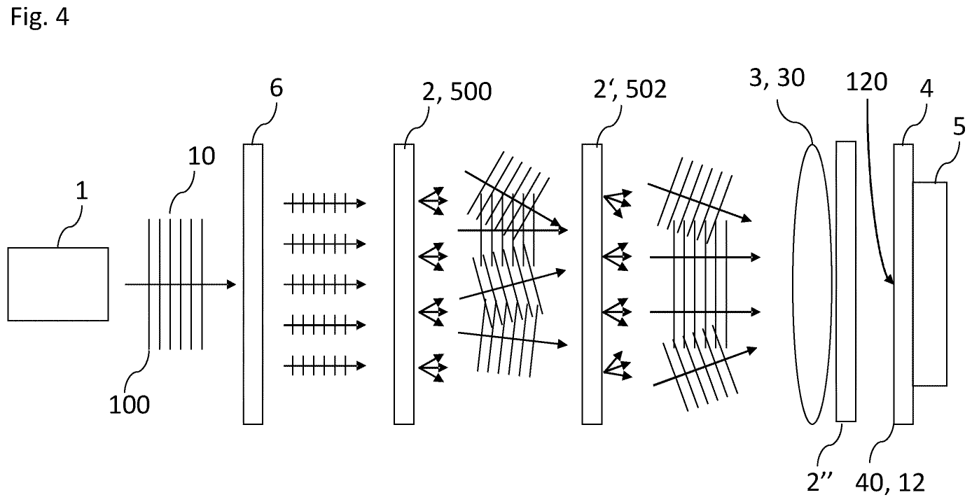

FIG. 4 shows a further embodiment of the device. In contrast to FIG. 2A, a further diffusing lens 2′′ is arranged behind the optical focusing system 30. The further diffusing lens 2′′ allows for further randomization of the intensity distribution in the focus zone 120.

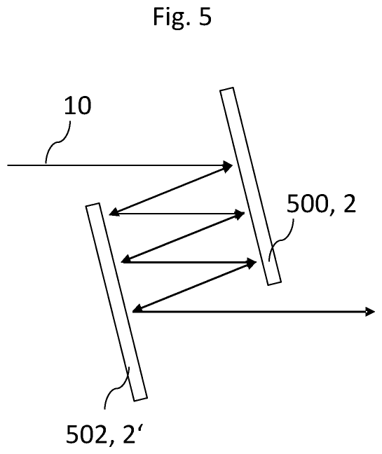

FIG. 5 shows an embodiment in which both scanner elements 500 and 502 comprise diffusing lenses 2 and 2′ that are designed to be reflective. For example, the laser beam 10 is incident on the first diffusing lens 2 at an angle and is then reflected onto the diffusing lens 2′ and thereby scattered. This process can be repeated several times until the scattered laser beam 10 is scattered by the second diffusing lens 2′ toward the focusing device 3. Here, both diffusing lenses 2, 2′ are designed as scanner elements 500, 502, such that as the laser beam 10 follows the advancing trajectory, it is incident on the respective diffusing lens 2, 2′ at different points, thereby further randomizing the intensity distribution in the focal plane 12.

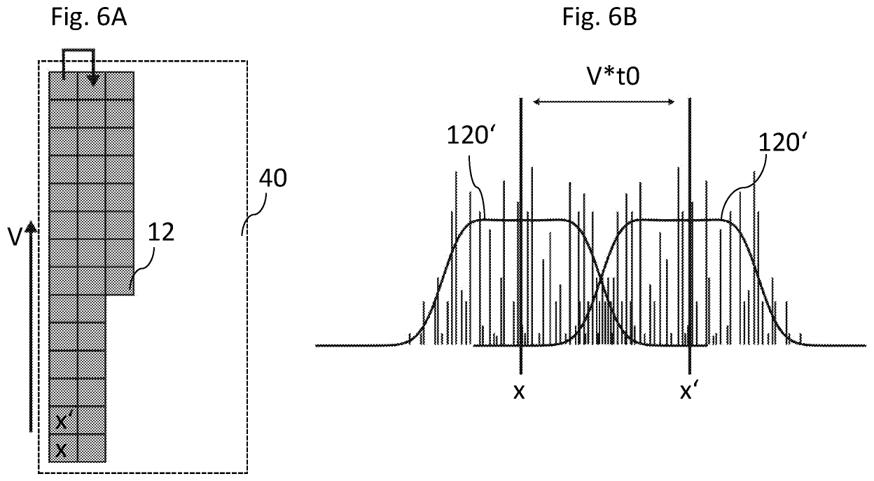

FIG. 6A shows a corresponding method for machining a workpiece 4. Here, laser pulses 100, which form a laser beam 10, are emitted with a laser 1. Using a scanner device 50 of the advancing device 5, the laser beam 10 is guided across the surface of the workpiece 4 along an advancing trajectory. To this end, the laser beam 10 is deflected by the scanner elements 500 and 502 and scattered at each of the scanner elements 500 and 502, which are designed as scattering elements 2 and 2′. The laser beam 10 is then focused onto the surface 40 of the workpiece 4 using an optical focusing system 3. The laser beam 10 is applied to the workpiece 4 in the focal plane 12, whereby it is machined. The intensity distribution of the laser beam is locally randomized on the focal plane 12, so that the surface 40 of the workpiece 4 can, for example, be functionalized, in particular provided with an anti-glare functionalization.

The workpiece 4 can also be displaced using an axis device 504 so that the focus zone 120 of the laser beam 10 successively sweeps the entire surface 40 or a portion of the surface 40 of the workpiece 4. Here, the focus zones 120 of the different laser pulses 100 can overlap. This means in particular that a first laser pulse 100 is introduced into a first focus zone 120 at a first location x in the material of the workpiece 4, while a second laser pulse 100′ is introduced into a second focus zone 120′ at a second location x′ in the material of the workpiece 4.

By moving the scanner elements 500, 502 relative to one another for advancement, different randomized intensity distributions are created in the various focus zones 120, 120'. Consequently, even with a uniform advancement, no uniform material modifications are created on the surface 40 of the workpiece 4, thereby preventing the formation of distracting interference or diffraction patterns when viewing the surface.

FIG. 6B shows that the different focus zones 120, 120′ of the laser pulses 100, 100′ introduced consecutively with the time pulse interval t0 can overlap in order to carry out the most planar machining of the workpiece 4 possible. Between the laser pulses 100, 100′, the scattering of the laser beam 10 can be changed by a corresponding relative movement of the diffusing lenses 2, 2′ in order to achieve an inhomogeneous material machining. For example, the advancement between laser pulses can range from 10 μm to 30 μm.

Insofar as applicable, all individual features presented in the exemplary embodiments can be combined with one another and/or interchanged, without departing from the scope of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Laser
10 Laser beam
12 Focal plane
120 Focus zone
100 Laser pulse
102 Partial laser beams
2 First diffusing lens
2′ Second diffusing lens
3 Optical focusing system
30 First lens
4 Workpiece
40 Workpiece surface
5 Advancing device
50 Scanner device
500 First scanner element
502 Second scanner element
52 Axis system
6 Beam shaping device
V Advancement

1. A device for machining a workpiece by impressing an anti-glare functionalization with laser pulses, comprising:
a short-pulse laser or an ultra-short-pulse laser configured to provide a laser beam with laser pulses;
a first diffusing lens and a second diffusing lens each configured to scatter the laser beam and to impress a locally randomized intensity distribution onto the laser beam in a focal plane,
wherein the first diffusing lens scatters the laser beam and the second diffusing lens scatters the scattered laser beam;
at least one optical focusing system configured to focus the laser beam onto a focus zone in the focal plane on the workpiece, wherein the laser beam is applied to the workpiece and the workpiece is machined as a result of the laser beam being applied to the workpiece; and
an advancing device configured to move the laser beam and the workpiece relative to one another, wherein the advancing device comprises a scanner having a first scanner element and a second scanner element, wherein a movement of the first and second scanner elements produces an advancement,
wherein the second scanner element comprises the second diffusing lens, and
wherein the movement of the first and second scanner elements modifies the locally randomized intensity distribution.

2. The device according to claim 1, wherein the first scanner element is arranged before or after the first diffusing lens and/or the first scanner element comprises the first diffusing lens.

3. The device according to claim 1, wherein at least one of the first diffusing lens and the second diffusing lens is configured to scatter the laser beam in transmission or reflection.

4. The device according to claim 1, wherein at least one of the first diffusing lens and the second diffusing lens has a binary phase pattern configured to impress a location-dependent phase difference on the laser beam, and wherein the location-dependent phase difference is defined in one or two dimensions.

5. The device according to claim 1, wherein the first diffusing lens is a spatial light modulator or a diffractive optical element.

6. The device according to claim 1, wherein the advancing device comprises an axis system.

7. The device according to claim 1, wherein the scanner comprises a galvanometer scanner and/or a polygon scanner.

8. The device according to claim 1, wherein the optical focusing system comprises a further diffusing lens.

9. The device according to claim 1, comprising a beam shaper configured to impress a flat-top beam shape on the laser beam.

10. The device according to claim 9, wherein the beam shaper is arranged in a beam propagation direction in front of the scanner.

11. A method for machining a workpiece by impressing an anti-glare functionalization with laser pulses of a short-pulse laser or an ultra-short-pulse laser, the method comprising:
scattering a laser beam by the laser pulses via a first diffusing lens and a second diffusing lens, wherein a locally randomized intensity distribution is impressed on the laser beam in a focal plane by the first and second diffusing lenses;
displacing the workpiece and the laser beam relative to one another along an advancing trajectory;
creating an advancement by movement of a first scanner element and a second scanner element of a scanner; and
focusing a scattered laser beam by an optical focusing system onto a focus zone in the focal plane on the workpiece, wherein the laser beam is applied to the workpiece and the workpiece is machined as a result of the laser beam being applied to the workpiece,
wherein the second scanner element is configured as the second diffusing lens, and
wherein relative movement of the first and second scanner elements is configured to modify the locally randomized intensity distribution.

12. The method according to claim 11, wherein the first scanner element is arranged before or after the first diffusing lens and/or the first scanner element comprises the first diffusing lens.

13. The method according to claim 11, wherein the focus zones of successive laser pulses overlap.

14. The method according to claim 11, wherein the focus zones cover a surface section of the workpiece.
